(19) United States
(12) Patent Application Publication
(10) Pub. No.: US 2008/0005385 A1
(43) Pub. Date: Jan. 3, 2008

(54) Passive mirroring through concurrent transfer of data to multiple target devices

(75) Inventors: Clark E. Lubbers, Colorado Springs, CO (US); David P. DeCenzo, Pueblo, CO (US)

Correspondence Address: Fellers, Snider, Blankenship, Bailey & Tippens, Suite 1700, 100 North Broadway, Oklahoma City, OK, 73102-8820, US

(73) Assignee: Seagate Technology LLC, Scotts Valley, CA (US)

(21) Appl. No.: 11/479,365

(22) Filed: Jun. 30, 2006

(51) Int. Cl. G06F 13/28; G06F 5/00

(52) U.S. Cl. 710/22; 710/52

(57) ABSTRACT

Method and apparatus for passively mirroring data to multiple storage locations. Data are concurrently transferred by a source device to at least first and second target devices over a common pathway. Respective first and second acknowledgement signals are supplied to the source device in response to the data transfer. In some embodiments, the data are synchronously clocked into first-in-first-out (FIFO) elements of the first and second target devices using a common clock signal. In other embodiments, the data are transferred to the first device at a first rate and are transferred to the second device at a second rate different from the first rate. The source device preferably comprises a functional controller core (FCC) of a multi-device array, and the target devices preferably comprise separate buffer managers. The source device further preferably updates a metadata structure in response to receipt of the first and second acknowledgement signals.

### FIELD OF THE INVENTION

The claimed invention relates generally to the field of data storage systems and more particularly, but not by way of limitation, to a method and apparatus for concurrently transferring data from a source device to multiple target devices such as in a multi-device data storage array.

### BACKGROUND

Storage devices are used to access data in a fast and efficient manner. Some types of storage devices use rotatable storage media, along with one or more data transducers that write data to and subsequently read data from tracks defined on the media surfaces.

Multi-device arrays (MDAs) can employ multiple storage devices to form a consolidated memory space. One commonly employed format for an MDA utilizes a RAID (redundant array of independent discs) configuration, wherein input data are stored across multiple storage devices in the array. Depending on the RAID level, various techniques including mirroring, striping and parity code generation can be employed to enhance the integrity of the stored data.

With continued demands for ever increased levels of storage capacity and performance, there remains an ongoing need for improvements in the manner in which storage devices in such arrays are operationally managed. It is to these and other improvements that preferred embodiments of the present invention are generally directed.

### SUMMARY OF THE INVENTION

Preferred embodiments of the present invention are generally directed to an apparatus and method for passively mirroring data to multiple storage locations, such as in a multi-device array.

In accordance with preferred embodiments, data are concurrently transferred by a source device to at least first and second target devices over a common pathway. Respective first and second acknowledgement signals are supplied to the source device in response to the data transfer.

In some embodiments, the data are synchronously clocked into first-in-first-out (FIFO) elements of the first and second target devices using a common clock signal. In other embodiments, the data are transferred to the first device at a first rate and are transferred to the second device at a second rate different from the first rate.

The source device preferably comprises a functional controller core (FCC), and the target devices preferably comprise separate buffer managers. The source device further preferably updates a metadata structure in response to receipt of the first and second acknowledgement signals. The data can further preferably comprise parity data generated and transferred on-the-fly by the source device to the respective first and second target devices.

These and various other features and advantages which characterize the claimed invention will become apparent upon reading the following detailed description and upon reviewing the associated drawings.

### BRIEF DESCRIPTION OF THE DRAWINGS

FIG. 1 generally illustrates a storage device constructed and operated in accordance with preferred embodiments of the present invention.

FIG. 2 is a functional block diagram of a network system which utilizes a number of storage devices such as illustrated in FIG. 1.

FIG. 3 provides a general representation of a preferred architecture of the controllers of FIG. 2.

FIG. 4 provides a functional block diagram of a selected intelligent storage processor of FIG. 3.

FIG. 5 sets forth a generalized representation of a source device connected to a number of parallel target devices.

FIG. 6 illustrates a parallel concurrent transfer of data to target devices in accordance with a preferred embodiment.

FIG. 7 illustrates a sequential concurrent transfer of data to target devices in accordance with an alternative preferred embodiment.

FIG. 8 represents an environment in which data are concurrently transferred to n target devices along a common pathway.

FIG. 9 shows a CONCURRENT DATA TRANSFER routine, generally illustrative of steps carried out in accordance with preferred embodiments of the present invention.

### DETAILED DESCRIPTION

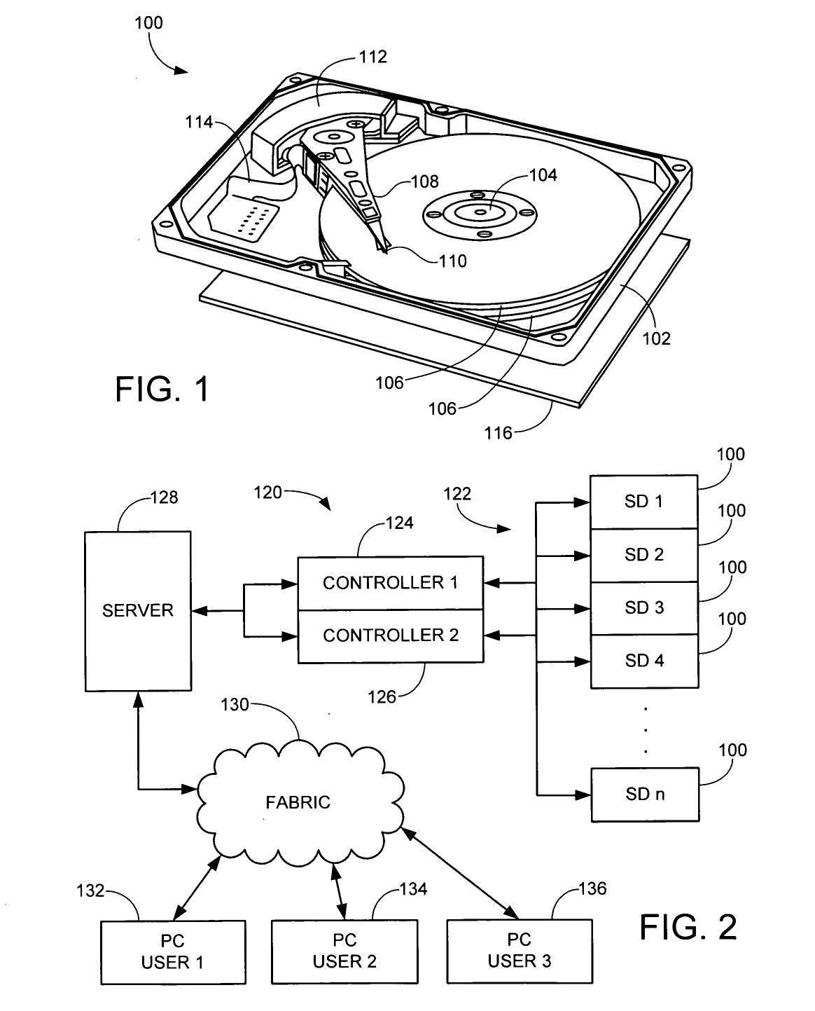

FIG. 1 shows an exemplary storage device 100 configured to store and retrieve user data. The device 100 is preferably characterized as a hard disc drive, although other device configurations can be readily employed as desired.

A base deck 102 mates with a top cover (not shown) to form an enclosed housing. A spindle motor 104 is mounted within the housing to controllably rotate media 106, preferably characterized as magnetic recording discs.

A controllably moveable actuator 108 moves an array of read/write transducers 110 adjacent tracks defined on the media surfaces through application of current to a voice coil motor (VCM) 112. A flex circuit assembly 114 provides electrical communication paths between the actuator 108 and device control electronics on an externally mounted printed circuit board (PCB) 116.

FIG. 2 generally illustrates an exemplary network system 120 that advantageously incorporates a number n of the storage devices (SD) 100 to form a consolidated storage space 122. Redundant controllers 124, 126 preferably operate to transfer data between the storage space 122 and a server 128. The server 128 in turn is connected to a fabric 130, such as a local area network (LAN), the Internet, etc.

Remote users respectively access the fabric 130 via personal computers (PCs) 132, 134, 136. In this way, a selected user can access the storage space 122 to write or retrieve data as desired.

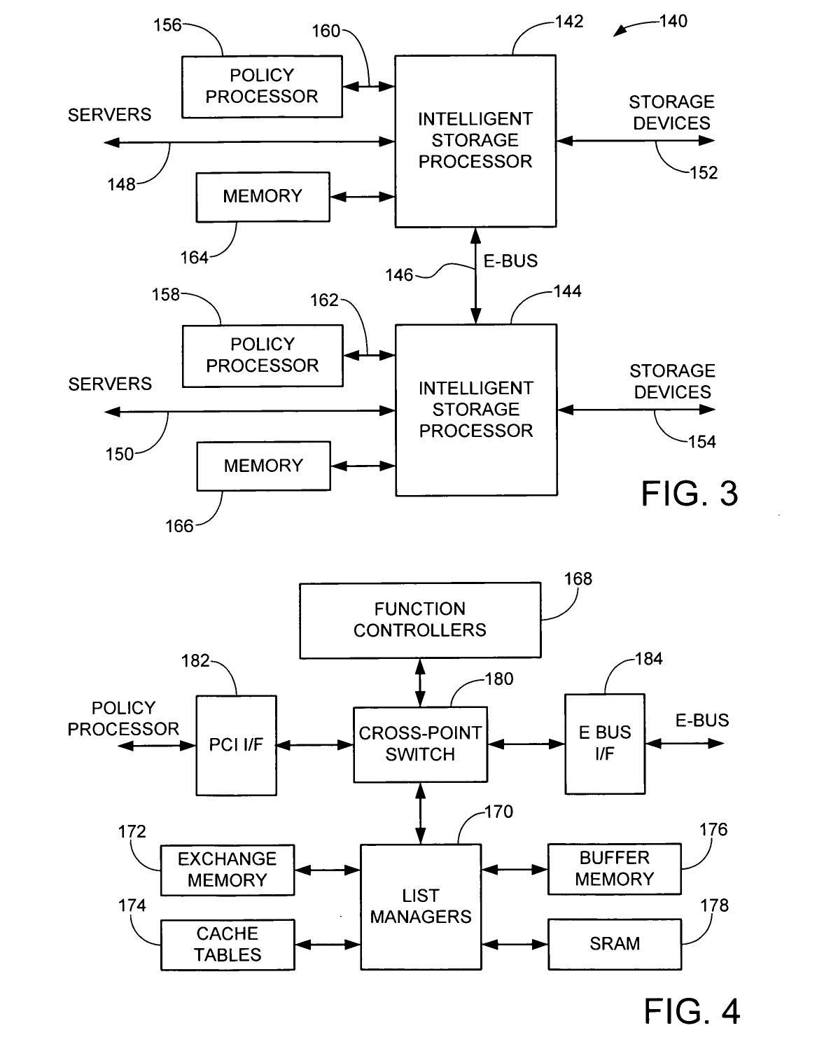

The devices 100 and the controllers 124, 126 are preferably incorporated into a multi-device array (MDA). The MDA preferably uses one or more selected RAID (redundant array of independent discs) configurations to store data across the devices 100. Although only one MDA and three remote users are illustrated in FIG. 2, it will be appreciated that this is merely for purposes of illustration and is not limiting; as desired, the network system 120 can utilize any number and types of MDAs, servers, client and host devices, fabric configurations and protocols, etc. FIG. 3 shows an array controller configuration 140 such as useful in the network of FIG. 2.

FIG. 3 sets forth two intelligent storage processors (ISPs) 142, 144 coupled by an intermediate bus 146 (referred to as an “E BUS”). Each of the ISPs 142, 144 is preferably disposed in a separate integrated circuit package on a common controller board. Preferably, the ISPs 142, 144 each respectively communicate with upstream application servers via fibre channel server links 148, 150, and with the storage devices 100 via fibre channel storage links 152, 154.

Policy processors 156, 158 execute a real-time operating system (RTOS) for the controller 140 and communicate with the respective ISPs 142, 144 via PCI busses 160, 162. The policy processors 156, 158 can further execute customized logic to perform sophisticated processing tasks in conjunction with the ISPs 142, 144 for a given storage application. The ISPs 142, 144 and the policy processors 156, 158 access memory modules 164, 166 as required during operation.

FIG. 4 provides a preferred construction for a selected ISP of FIG. 3. A number of function controllers, collectively identified at 168, serve as function controller cores (FCCs) for a number of controller operations such as host exchange, direct memory access (DMA), exclusive-or (XOR), command routing, metadata control, and disc exchange. Each FCC preferably contains a highly flexible feature set and interface to facilitate memory exchanges and other scheduling tasks.

A number of list managers, denoted generally at 170 are used for various data and memory management tasks during controller operation, such as cache table management, metadata maintenance, and buffer management. The list managers 170 preferably perform well-defined albeit simple operations on memory to accomplish tasks as directed by the FCCs 168. Each list manager preferably operates as a message processor for memory access by the FCCs, and preferably executes operations defined by received messages in accordance with a defined protocol.

The list managers 170 respectively communicate with and control a number of memory modules including an exchange memory block 172, a cache tables block 174, buffer memory block 176 and SRAM 178. The function controllers 168 and the list managers 170 respectively communicate via a cross-point switch (CPS) module 180. In this way, a selected function core of controllers 168 can establish a communication pathway through the CPS 180 to a corresponding list manager 170 to communicate a status, access a memory module, or invoke a desired ISP operation.

Similarly, a selected list manager 170 can communicate responses back to the function controllers 168 via the CPS 180. Although not shown, separate data bus connections are preferably established between respective elements of FIG. 4 to accommodate data transfers therebetween. As will be appreciated, other configurations can readily be utilized as desired.

A PCI interface (I/F) module 182 establishes and directs transactions between the policy processor 156 and the ISP 142. An E-BUS I/F module 184 facilitates communications over the E-BUS 146 between FCCs and list managers of the respective ISPs 142, 144. The policy processors 156, 158 can also initiate and receive communications with other parts of the system via the E-BUS 146 as desired.

The controller architecture of FIGS. 3 and 4 advantageously provides scalable, highly functional data management and control for the array. Preferably, stripe buffer lists (SBLs) and other metadata structures are aligned to stripe boundaries on the storage media and reference data buffers in cache that are dedicated to storing the data associated with a disk stripe during a storage transaction. To enhance processing efficiency and management, data may be mirrored to multiple cache locations within the controller architecture during various data write and read operations with the array.

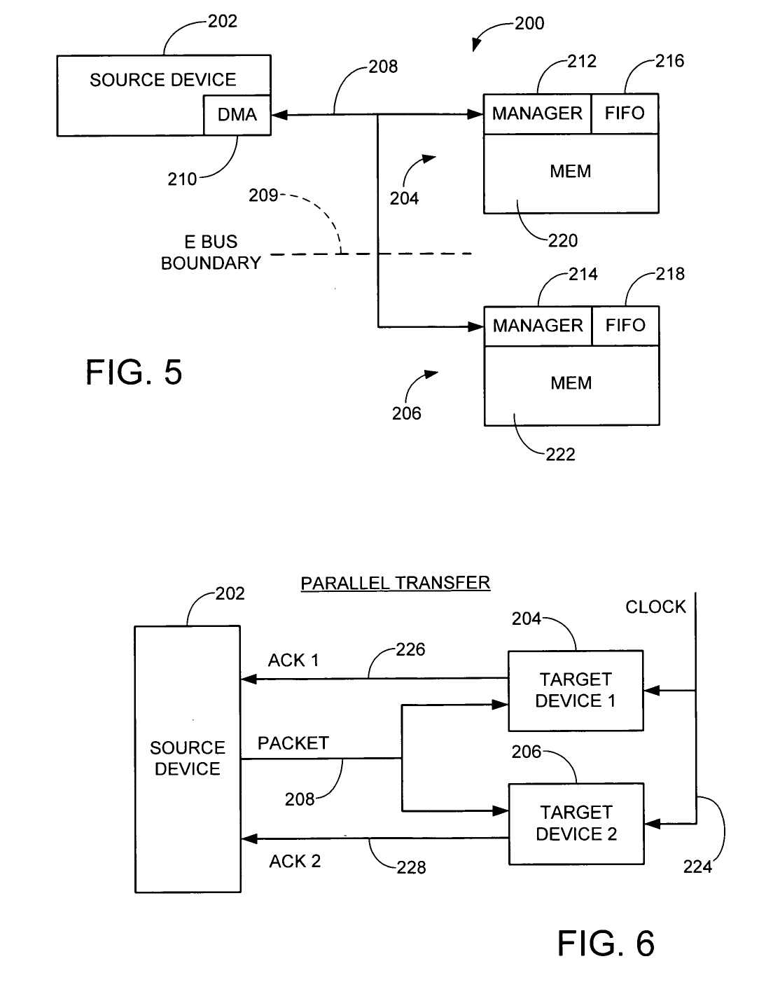

Accordingly, FIG. 5 shows a generalized, exemplary data transfer circuit 200 to set forth preferred embodiments of the present invention in which data are passively mirrored to multiple target devices. The circuit 200 preferably represents selected components of FIGS. 3 and 4, such as without limitation a selected FCC in combination with one or more address generators (AG) of the respective ISPs 142, 144. For example, during operation the FCCs send packets to the AGs with various information such as the SBL, offset and sector counts for a particular DMA exchange. The AGs preferably operate to fetch buffer indices from the SBLs and calculate buffer addresses and counts which are then placed in the appropriate address/count FIFO indicated by the “client” identified in the packet.

A source device 202 preferably communicates with first and second target devices 204, 206 via a common pathway 208, such as a multi-line data bus. The pathway in FIG. 5 is shown to extend across an E-Bus boundary 209, although such is not necessarily required. The source device 202 preferably includes bi-directional (transmit and receive) direct memory access (DMA) block 210, which respectively interfaces with manager blocks 212, 214 of the target devices 204, 206.

The source device 202 is preferably configured to concurrently transfer a data, such as a data packet, to the first and second target devices 204, 206 over the pathway 208. Preferably, the data packet is concurrently received by respective FIFOs 216, 218 for subsequent movement to memory spaces 220, 222, which in the present example preferably represent different cache memory locations within the controller architecture.

In response to receipt of the transferred packet, the target devices 204, 206 each preferably transmit separate acknowledgement (ACK) signals to the source device to confirm successfully completion of the data transfer operation. The ACK signals can be supplied at the completion of the transfer or at convenient boundaries thereof.

In a first preferred embodiment, the concurrent transfer takes place in parallel as shown by FIG. 6. That is, the packet is synchronously clocked to each of the FIFOs 216, 218 using a common clock signal such as represented via path 224. In this way, a single DMA transfer preferably effects transfer of the data to each of the respective devices. The rate of transfer is preferably established in relation to the transfer rate capabilities of the pathway 208, although other factors can influence the transfer rate as well depending on the requirements of a given environment.

Although not required, it is contemplated that such synchronous transfers are particularly suitable when the target devices are nominally identical (e.g., buffer managers in nominally identical chip sets such as the ISPs 142, 144). However, transfers can take place to different types of devices so long as the transfer rate can be accommodated by the slower of the two target devices. Upon completion, each device 204, 206 supplies a separate acknowledgement (ACK1 and ACK 2) via separate communication paths 226, 228 as shown.

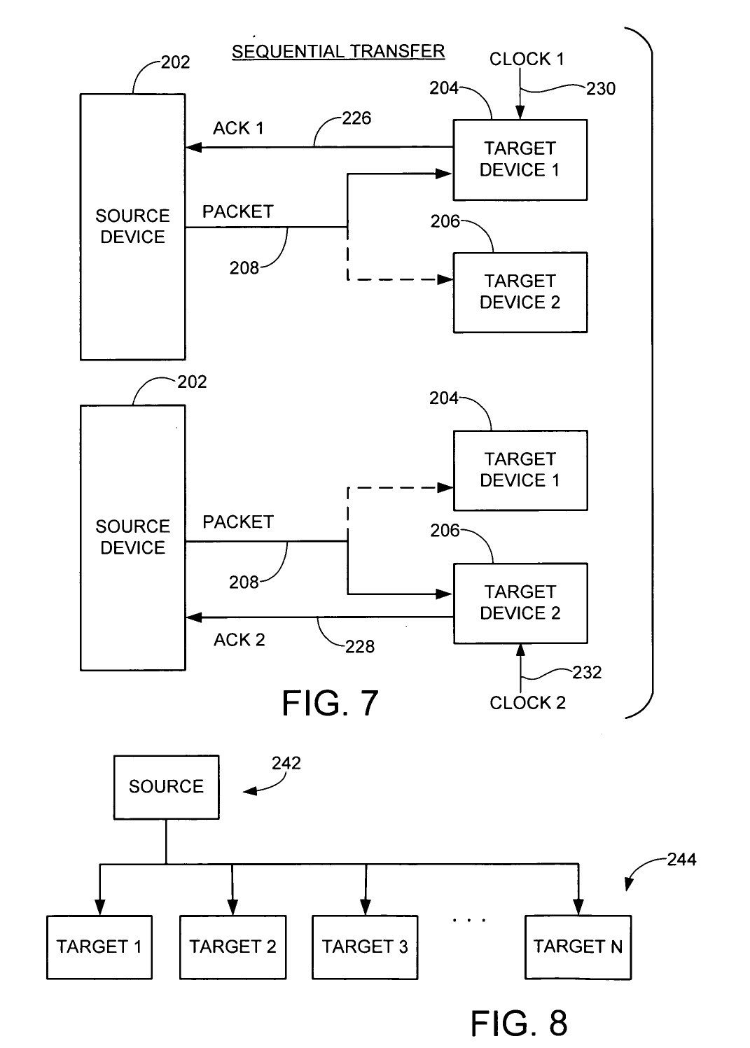

Alternatively, FIG. 7 sets forth a sequential transfer whereby the data are passively mirrored to the two target devices at different rates. That is, the upper half of FIG. 7 represents data flows along pathway 208 to the first target device 204, while the lower half of FIG. 7 represents data flows to the second target device 206.

All of the data can be written to the first device 204 prior to the writing of the data to the second device 206; alternatively, portions of the overall data packet can be alternately sent to the respective devices in turn. It will be noted that the sequential transfer may preferably involve duplicate DMA operations to each target device. The transfers may further take place at different rates, such as indicated by separate clock input lines 230, 232.

As before, the devices supply respective ACK1 and ACK2 signals back to the source device 202 at the conclusion of the data transfer to confirm successful receipt of the data. Additional acknowledgement signals can also be sent at appropriate times during the transfer as well. Other alternatives are also contemplated, including the transfer of a data packet some portions of which are transferred in parallel and other portions of which are transferred sequentially.

It will be noted that the foregoing alternative approaches advantageously mirror the data in multiple locations in an efficient manner while providing separate confirmation for each written data set. For example, as shown in FIG. 8 a source device 242 can concurrently transfer data to any number of target devices, such as devices 1-N shown collectively at 244, in accordance with the foregoing embodiments. At least one, and preferably multiple DMA operations are eliminated since the data are not written to a first target device by the source, and then subsequently read out of the first device and transferred to the second device as in the prior art.

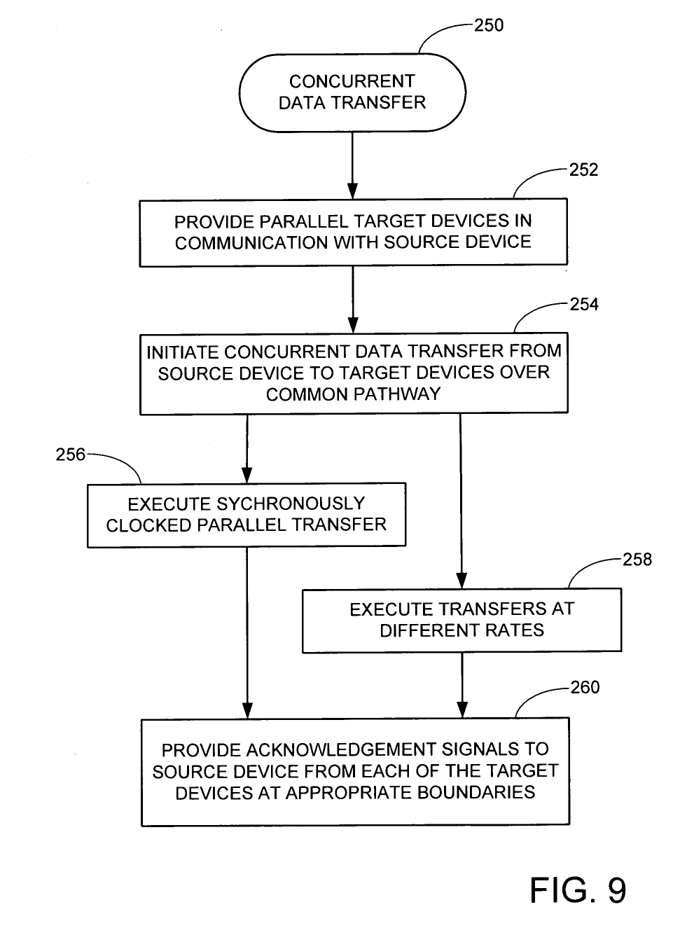

FIG. 9 provides a flow chart for a CONCURRENT DATA TRANSFER routine 250, generally illustrative of preferred steps carried out in accordance with preferred embodiments of the present invention.

At step 252, parallel target devices, such as 204, 206 are first provided in communication with a source device such as 202 via a communication pathway. This pathway can include a physical chipset boundary such as shown in FIG. 5 so that the respective target devices are in different physical chipsets. The pathway can further include multiple busses so long as the data are transferred at least along a portion of the same physical connection during transfer to the respective target devices.

At step 254, a concurrent data transfer is initiated from the source device to the target devices. For example, the source device may include a FIFO or other memory space that stores data received from the server 128 for ultimate storage to the devices 100. In such case, the data may be desirably mirrored within the controller architecture 140 during the processing of this data in preparation for subsequent writing of the data to the media 106.

The concurrent transfer can comprise a synchronously clocked transfer as shown by step 256, and/or a sequential transfer that takes place at different rates as shown by step 258.

At step 260, separate acknowledgement (ACK) signals are transmitted back to the source device to confirm receipt. While it is contemplated that the target devices will be configured to transmit the ACK signals automatically, it will be appreciated that the separate signals can be forwarded in response to a subsequent polling request initiated by the source device.

Further processing can take place as desired once the data are acknowledged as being successfully mirrored. For example, SGL, SBL and other metadata structures can be accurately maintained and updated in real time based on the confirmation supplied by the respective ACK signals.

The source device can generate the data as a result of an ongoing processing operation, such as an XOR operation to generate higher level RAID parity values (e.g., RAID-5, RAID-6, etc.). In this case, the data are preferably generated and passively mirrored to multiple target locations on-the-fly.

The foregoing embodiments have preferably characterized the data transferred by the source to the target devices as comprising array data; that is, data that is ultimately striped to the media 106 during a write operation, or data that has been recovered from the media 106 during a read operation. However, such is not necessarily required. Rather, the data can take any number of forms, including metadata structures (including SGLs or SBLs, etc.), commands, status information, or other inter-device communications.

While preferred embodiments presented herein have been directed to a multi-device array utilizing a plurality of disc drive storage devices, it will be appreciated that such is merely for purposes of illustration and is not limiting. Rather, the claimed invention can be utilized in any number of various environments to promote efficient data mirroring.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application without departing from the spirit and scope of the present invention.

What is claimed is:

1. An apparatus comprising a source device configured to concurrently transfer data to first and second target devices over a common pathway and to receive respective first and second acknowledgement signals from the respective first and second target devices in response thereto.

2. The apparatus of claim 1, wherein the data are synchronously clocked into first-in-first-out (FIFO) elements of the first and second target devices using a common clock signal.

3. The apparatus of claim 1, wherein the data are transferred to the first device at a first rate and are transferred to the second device at a second rate different from the first rate.

4. The apparatus of claim 1, wherein the source device comprises a functional controller core (FCC) of a multi-device array.

5. The apparatus of claim 4, wherein the first and second target devices each respectively comprise a buffer manager of the multi-device array.

6. The apparatus of claim 1, wherein the source device and the first target device are disposed in a first integrated circuit package, and wherein the second target device is disposed in a second integrated circuit package in communication with the first integrated circuit package.

7. The apparatus of claim 1, wherein the source device further operates to update a metadata structure in response to receipt of the first and second acknowledgement signals.

8. The apparatus of claim 1, wherein data are characterized as parity data generated and transferred on-the-fly by the source device to the respective first and second target devices.

9. A method comprising concurrently transferring data from a source device to first and second target devices via a common pathway, and transmitting first and second acknowledgement signals to the source device to respectively confirm receipt of the data by the respective first and second target devices.

10. The method of claim 9, wherein the transferring step comprises synchronously clocking the data packet into the first and second target devices using a common clock signal.

11. The method of claim 9, wherein the transferring step comprises transferring the data to the first device at a first rate and transferring the data to the second device at a second rate.

12. The method of claim 9, wherein the first acknowledgement signal is transmitted from the first target device to the source device via a first pathway, and wherein the second acknowledgement signal is transmitted from the second target device to the source device via a second pathway.

13. The method of claim 9, wherein the source device of the transferring step comprises a functional controller core of a multi-device array.

14. The method of claim 13, wherein the first and second target devices of the transferring step each respectively comprise a buffer manager of the multi-device array.

15. The method of claim 9, wherein the transferring step comprises at least one direct memory access (DMA) operation by the source device.

16. The method of claim 9, wherein the source device and the first target device are disposed in a first integrated circuit package, and wherein the second target device is disposed in a second integrated circuit package in communication with the first integrated circuit package.

17. The method of claim 16, wherein the first integrated circuit package forms a first intelligent storage processor (ISP), and wherein the second integrated circuit package forms a second ISP in communication with the first ISP via an E-Bus.

18. The method of claim 9, further comprising a step of updating a metadata structure in response to receipt of the first and second acknowledgement signals.

19. The method of claim 9, wherein the data transferred by the source device comprises parity data generated by said source device.
